(19) United States
(12) Patent Application Publication
(10) Pub. No.: US 2021/0160340 A1
(43) Pub. Date: May 27, 2021

(54) CROSS-PLATFORM DIGITAL CONTENT STORAGE AND SHARING SYSTEM

(71) Applicant: INIKA LLC, Torrance, CA (US)

(72) Inventor: Padmanabhan Narayanan, Torrance, CA (US)

(21) Appl. No.: 17/259,182

(22) PCT Filed: Sep. 17, 2019
(86) PCT No.: PCT/US19/51493

§ 371 Date: Jan. 10, 2021

Related U.S. Application Data
(60) Provisional application No. 62/732,391, filed on Sep. 17, 2018.

(51) Int. Cl. H04L 29/08; H04L 9/32

(52) U.S. Cl. CPC H04L 67/306; H04L 67/06; H04L 67/2804; H04L 9/3239; H04L 67/1095; H04L 67/12; H04L 67/20; H04L 67/02

(57) ABSTRACT

A content sharing system for peer-to-peer private sharing of digital content between users of a sharing platform is configured, using application programs executing on the users' mobile devices, so that the content can only be used (e.g., viewed, shared, etc.) by the receiver from within an instance of the application executing on an authorized receiving device, and only if the owner has set permissions allowing the receiver to perform the requested action. The owner can modify these permissions and promulgate the changes to the platform users via the network of user devices, causing the applications of impacted users to allow or deny activity, and keep or discard data, accordingly. Further, each transaction involving the shared content can be recorded to each parties' private or synchronized shared ledgers, creating a complete interaction timeline that essentially bestows the content with “memory” of how it has been shared.

### CROSS-REFERENCE TO RELATED APPLICATIONS

This application claims the benefit of priority from U.S. Prov. Pat. App. Ser. No. 62/732,391, entitled “CONTENT SHARING SYSTEM REDUCING DUPLICATIVE DATA ACROSS NETWORKED COMPUTING DEVICES,” filed Sep. 17, 2018, and incorporated fully herein by reference.

### BACKGROUND

The field of technology of the invention is digital content storage and sharing systems for networked computing devices, particularly for cross-platform mobile-to-mobile transmissions. The invention tackles several significant inefficiencies in current peer-to-peer image sharing technology, which especially arise when a user of one device type (e.g., an APPLE IPHONE smartphone) tries to send digital content, such as an image captured with his device, to another user's device of a different type (e.g., a device using the ANDROID operating system).

First, the store-share-store process creates multiple unnecessary copies of the image, which waste storage space until they are manually deleted by the users: 1) a captured image is saved to the sender's device; 2) the image is synced to the sender's cloud storage via a native or third-party storage service; 3) the sender sends the image in an SMS text message, creating another copy of the image in the sender's messaging app; 4) the receiver receives the SMS text message, creating another copy of the image in the receiver's messaging app; 5) the receiver saves the image to device storage; 6) the image is synced to the receiver's cloud storage. Thus, five or more copies of each image are created when the image is shared.

Second, some or all of the metadata storing “rich properties” of the image, such as date and GPS location of capture, author ID, image capture settings, etc., are stripped from the image or otherwise rendered unusable when the image is transferred. This is especially true for cross-platform shared images, because some metadata formatting is proprietary and/or encrypted, but even standardized metadata (e.g., using the exchangeable interface file format, or EXIF) is often damaged or removed by the sending device or the receiving device. The receiver would have to manually add the rich properties back into the image data structure to use them for organization, search, and identification purposes.

Third, the sharing user loses control over other users' access to the image. To wit, once the original receiver (or receivers) receives the image from the original sender in an SMS message or a or peer-to-peer messaging/photo app, the receiver can store the image locally or in the cloud and the sender can neither delete the receiver's copy/ies nor prevent the receiver from viewing the image at-will. Furthermore, the sender cannot prevent the receiver from copying or editing the image to produce new image files, from sharing the image on social media or other for a, or from sending the image to other users of the peer-to-peer system, each of which then becomes the receiver whose access to the image is not controlled by the original sender or any intermediate senders. The sharing user and other senders also have no visibility of the transactions involving the image performed by any of the receivers or any other user or non-user entity that obtains access to the image. That is, the senders do not know a transaction—such as saving, viewing, editing, renaming, grouping, sending, or deleting the image—even occurred, let alone what the details of the transaction are.

Finally (though the drawbacks described here are not exhaustive), many benefits of aggregating data across users and analyzing the aggregated data to identify optimizations and additional features cannot be realized, because information describing shared content and its associated transactions is neither centralized (e.g., in cloud storage or other remote database, where it can be aggregated across users) nor uniformly formatted so that at least the metadata of the content can be extracted from user devices and aggregated. Consequently, the efficiency of content management suffers. For example, management features such as image grouping, face and identity recognition, duplicate detection, image searching, and the like, rely on machine learning algorithms and other artificial intelligence that produces the most accurate, or at least useful, data models and comparative results when provided with the “complete universe” of available data. In peer-to-peer services, the data model is derived separately for each user from data describing how that user uses the service, rather than from data describing how all users use the service. Additionally, some device platforms can only analyze “native” data formats, further limiting the usage information available to build the data model.

### BRIEF DESCRIPTION OF THE DRAWINGS

Various techniques will be described with reference to the drawings, in which:

FIG. 1 is a diagram of an example embodiment of data flow between computing devices executing the sharing application in accordance with this disclosure;

FIG. 2 is a diagram of a computing environment in which various embodiments of the present systems and methods can be implemented in accordance with this disclosure;

FIG. 3 is a diagram of another example embodiment of data flow between computing devices executing the sharing application in accordance with this disclosure;

FIG. 4A is a flowchart illustrating an example method of processing a request to send content from a sender to a recipient, from the sender's side of the transaction;

FIG. 4B is a flowchart illustrating an example method of processing a confirmation that the recipient responded to the request to send processed in FIG. 4A;

FIG. 5A is a flowchart illustrating an example method of processing a request to send content from a sender to a recipient, from the recipient's side of the transaction;

FIG. 5B is a flowchart illustrating an example method of obtaining shared content;

FIG. 5C illustrates another example of method for obtaining the content shared via the request;

FIG. 6A is a flowchart illustrating an example method of generating application-specific metadata, in accordance with this disclosure;

FIG. 6B is a flowchart illustrating example methods of automatically tagging content, in accordance with this disclosure;

FIG. 7 is a flowchart illustrating an example method of receiving shared content having metadata formatted for use by the receiving device;

FIG. 8 illustrates an example of a set of processes;

FIG. 9 schematically shows a process implementing a content owner's revocation of the receiver's access to shared content;

FIG. 10 is a diagram of an example computing device specially configured to implement the presently described systems and methods; and

FIG. 11 is a diagram of another computing environment in which various embodiments of the present systems and methods can be implemented in accordance with this disclosure.

### DETAILED DESCRIPTION

The present invention provides systems and methods for sharing digital content between users of several types of computing devices, addressing at least the drawbacks described above. In some embodiments, the invention includes a mobile and web application for image sharing and organization that interfaces with on-device file structures and storage and communication applications in order to, among other functions, retain original and customized metadata of a shared image across device transfers, create new metadata of an image, maintain a record of transactions for an image, set and change access and use permissions for a shared image, process changes to the permissions for a received image, and process requests to access and/or use a shared image using the permissions and lightweight encryption of the image data. In some embodiments, the application may also or instead access common cloud storage environments to execute the above functions on image and other content data stored therein.

In some embodiments, the system may configure a device executing the application to maintain a persistent copy of an element of digital content only in (a) storage location(s) specified by a user of the device. The storage location may be local storage of the device itself, or cloud-based storage that the user has implemented outside and exclusive of the present system. For example, the cloud-based storage may be a “native” storage service, such as the ICLOUD storage service provided by APPLE and used natively by APPLE computing devices or the GOOGLE PLAY storage service provided by GOOGLE and used natively by ANDROID-based devices; or, the storage service may be a “third-party” storage service implemented and managed by other systems and applications, such as the PRIME PHOTOS application, provided by AMAZON, that uses AMAZON WEB SERVICES cloud storage resources. Advantageously, the present system's operations facilitate transmission of content between these user-designated storage services, rather than implementing the system's own server-side content storage services.

Furthermore, the present system may configure a device executing the application to use peer-to-peer communication channels to facilitate sharing of content from one user to another, without loss of original metadata associated with the content. Metadata is preserved, and may be encrypted for security, by the sending device, and may be decrypted by the receiving device, the receiving device reconstituting the content with the metadata in the device's native schema so that the rich properties of the content can be used by the recipient. Additional rich properties may be identified by the application and used to “tag” the content for categorization and searching. The recipient may choose to reject the request to share content, and no persistent copies of the content are made. If the recipient accepts, a single persistent copy of the content (with metadata) may be made in the user-specified storage location(s); thus, as few as two instances of the content remain after the sharing process is complete—the original content in the sender's storage, and the copy in the recipient's storage. The system may maintain a ledger in each user's storage location, which records the transactions made involving each element of content in the storage.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

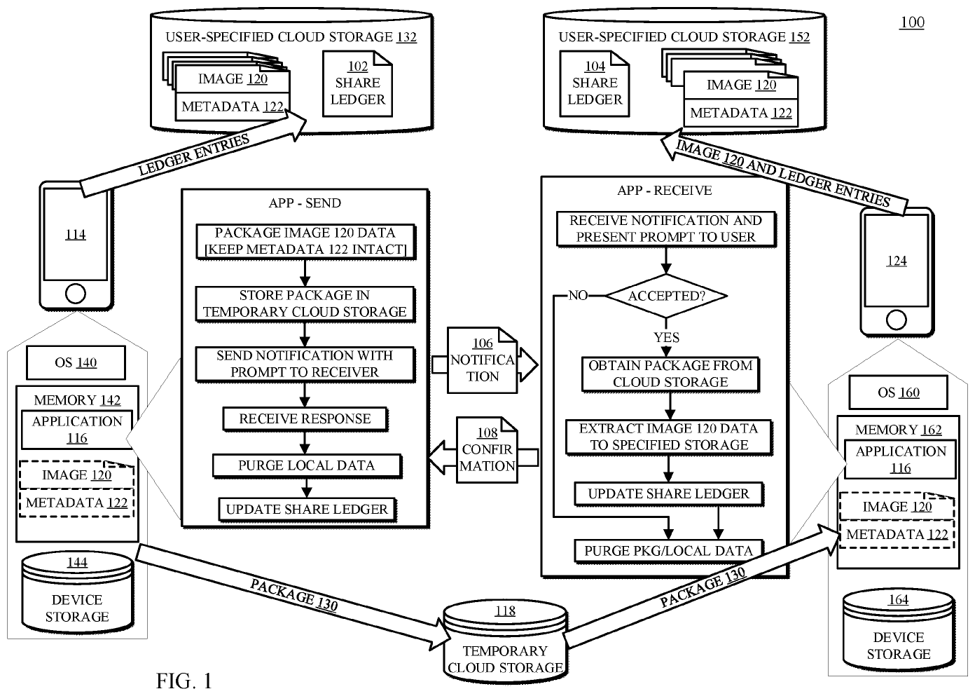

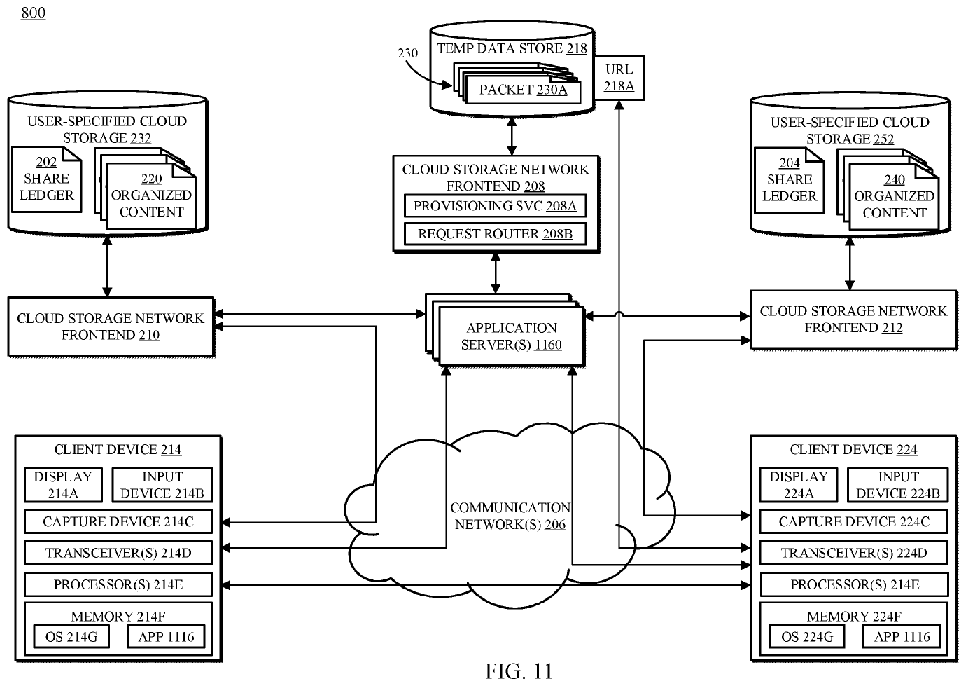

Referring to FIG. 1, embodiments of the present disclosure may operate within or upon computing systems of a computing environment 100 accessible by users of user computing devices 114, 124 via a computer network such as the internet. FIG. 1 illustrates the conceptual operation of the present systems and methods implemented as a software application 116 installed on user devices 114, 124 each associated with a user account of a registered user of the system. The environment 100 illustrates an example in which a sender may attempt to share content, such as a digital image, with a recipient using the application 116 installed on the parties' respective registered devices 114, 124. In other embodiments, the application 116, or a browser application, or another application, installed on a device 114, 124 may interface with one or more application servers that cooperate to perform the request and content processing methods described herein. See FIG. 11. The application 116 may comprise computer program instructions stored in memory 142, 162 of the corresponding device 114, 124; these instructions may be formatted for execution by one or more processors of the device 114, 124, and when executed, may cause the corresponding device 114, 124 to perform the application 116 tasks described herein. The application 116 may be formatted to execute within runtime and other execution environments, and to access file systems, provided within computing resources of the device 114, 124 according to the operating system 140, 160 of the corresponding device 114, 124. In particular, the application 116 may enable platform-agnostic sharing of content and the associated rich properties, even when a first operating system 140 (e.g., APPLE IOS) and a second operating system 160 (e.g., ANDROID) of the devices 114, 124 are not generally compatible and/or natively excise some or all original metadata from the content when sharing between them.

FIG. 1 illustrates an example transaction in which two registered system users use the application 116 installed on their respective devices 114, 124 to share digital content, such as an image 120. Between the users' devices 114, 124 and the associated storage resources described further below, the application 116 may, in some embodiments, cause the devices 114, 124 to do the following:
The sending device 114 packages the image 120 and original metadata 122 into a structured data package 130, stores the package 130 in temporary cloud storage 118, and sends a notification 106 to the receiving device 124;
The receiving device 124 receives the notification 106, presents a prompt to the recipient to accept or reject the request to share the image 120, and processes the recipient's response;
If the recipient accepts the request, the receiving device 124 obtains the package 130 from the temporary cloud storage 118, extracts the image 120 and metadata 122, stores the image and metadata 122 in the user-specified storage location(s) (e.g., local device storage 164 of the device 124 or cloud storage 152 associated with the recipient), and updates the recipient's share ledger 104 (described further below, and stored in the user-specified storage location(s)) to include an entry describing the received image 120;
After storing the image 120 and metadata 122, or if the recipient rejects the request, the receiving device 124 deletes any locally-saved (e.g, in memory 162) data regarding the request, and prepares and sends a confirmation 108 to the sending device indicating whether the share was accepted and completed;
The sending device 114 waits a preset request time-out period to receive the confirmation 108; upon receiving the confirmation 108, or if the request times out, the sending device 114 updates the sender's share ledger 102 (saved in the user-specified storage location, such as cloud storage 132 with the sender's content (including image 120) to include an entry describing the result of the share (i.e., accepted or rejected), and deletes any locally-saved (e.g, in memory 142) data regarding the request; and
Either device 114, 124 may delete the package 130 from temporary cloud storage 118 (or allow a storage timer to expire) once the preceding tasks are complete.

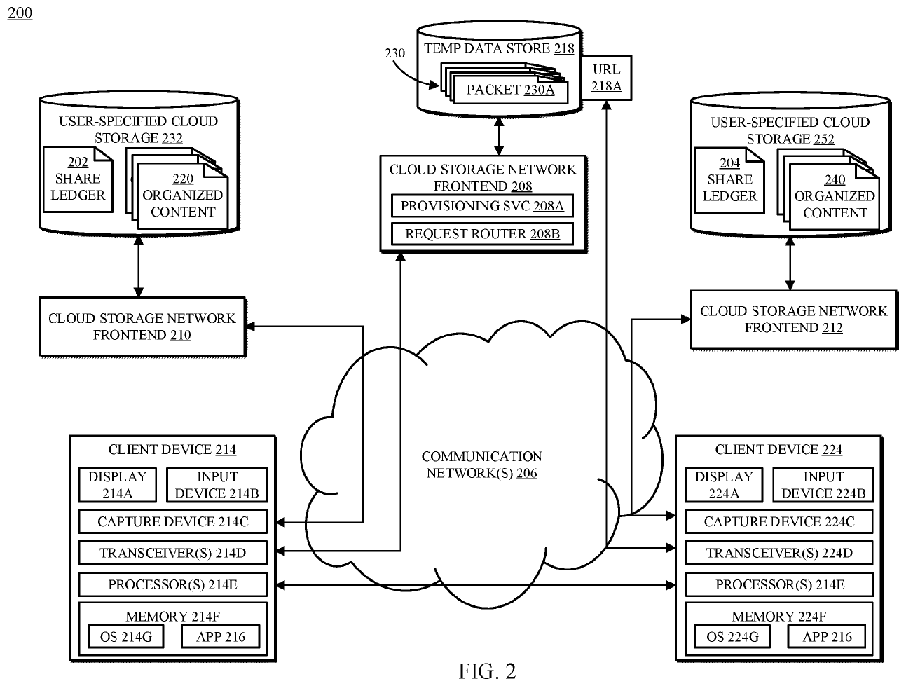

FIG. 2 illustrates an example computing architecture 200 that facilitates the efficient exchange of content data described above with respect to FIG. 1. The diagram illustrates computing systems, networks, and other computing resources; it will be understood that various non-illustrated components may nonetheless be present in the computing architecture 200 and are omitted for clarity. For example, the computing architecture 200 may include physical and virtual network adapters, application programming interfaces (APIs), and other hardware and/or software interfaces that facilitate connections between the computing resources as illustrated. In addition, the computing architecture 200 may include data processing architecture that implements systems and services that operate “outside” of any particular system component or virtual computing environment, and that perform various back-end functions such as managing communications between computing environments, providing electronic data storage, and performing encryption, compression, and other data analysis functions. These systems and services may communicate with each other and/or with devices and services outside of the computing architecture 200. It will be understood that systems and services depicted in the Figures may be suitably modified to operate in the computing architecture 200 in a different fashion that what is depicted.

In general, user computing devices 214, 224 can be any computing device such as a desktop, laptop, mobile phone (or smartphone), tablet, kiosk, wireless device, and other electronic devices. In addition, the user computing devices 214, 224 may include web services running on the same or different data centers, where, for example, different web services may programmatically communicate with each other to perform one or more techniques described herein. Further, the user computing devices 214, 224 may include Internet of Things (IoT) devices such as Internet appliances and connected devices. Such systems, services, and resources may have their own interface for connecting to other components, some of which are described below. Although one or more embodiments may be described herein as using a user interface, it should be appreciated that such embodiments may, additionally or alternatively, use any CLIs, APIs, or other programmatic interfaces. A physical or virtual user computing device 214, 224 may include special-purpose hardware and software designed to enable the computing device 214, 224; such components include, for example, a display 214A, 224A, one or more input devices 214B, 224B such as a mouse or keyboard (or a combination display/input device, such as a touchscreen), a camera or other capture device 214C, 224C, one or more transceivers 214D, 224D for communicating over various communication networks 206 (e.g., wifi, the internet, Bluetooth), one or more processors 214E, 224E, and computer memory 214F, 224F (e.g., RAM and/or ROM) storing software program instructions for execution by the device processors 214E, 224E. Such software commonly includes an integrated or installed operating system 214G, 224G; in some embodiments, the software stored in memory 214F, 224F further includes an application 216 that implements the sharing system, as described by example above.

A network 206 that connects a user device 214 to another user device 224 and/or to other systems and computing environments may be any wired network, wireless network, or combination thereof. In addition, a network 206 may be a personal area network, local area network, wide area network, over-the-air broadcast network (e.g., for radio or television), cable network, satellite network, cellular telephone network, or combination thereof. In some embodiments, a network 206, may be a private or semi-private network, such as a corporate or university intranet. A network 206 may include one or more wireless networks, such as a Global System for Mobile Communications (GSM) network, a Code Division Multiple Access (CDMA) network, a Long Term Evolution (LTE) network, or any other type of wireless network. A network 206 can use protocols and components for communicating via the Internet, by cellular communications, or within any of the other aforementioned types of networks. For example, the protocols used by a network 206 may include Hypertext Transfer Protocol (HTTP), HTTP Secure (HTTPS), Message Queue Telemetry Transport (MQTT), Constrained Application Protocol (CoAP), short messaging service (SMS), and the like. Protocols and components for communicating via the Internet or any of the other aforementioned types of communication networks are well known to those skilled in the art and, thus, are not described in more detail herein.

Interfaces between the network(s) 206 and connected components including the user computing devices 214, 224 and the cloud storage network frontend(s) 208, 210, 212 may be any suitable user interface that is compatible with the corresponding component(s) and the network 206, such as an API, a web application, web service, or other interface accessible using a web browser or another software application, a command line interface, and the like. In some embodiments, the application 216 may provide a user interface including code and/or instructions for generating a graphic console on the corresponding display 214A, 224A using, for example, markup languages and other common web technologies. User input (e.g., text, computer files, selected elements from a list or menu, mouse clicks on buttons, and other interactions) entered into the user interface by the user (e.g., via the corresponding input device 214B, 224B) may be received and processed by the resident application 216 and/or by one or more components of the computing architecture 200. For example, the sender may interact with the user interface to select content to share, select a recipient for the request to share, and generate the request, while the recipient may interact with the user interface to view the notification and prompt, and to enter a selection of “accept” or “reject” in response to the request to share. In another example, the user of a device 224 may launch the application 216 and then use the application's 216 user interface to register with the sharing system and provide one or more settings, such as the user-specified storage location and the login credentials for accessing the corresponding storage service; the application 216 may store these settings in device memory 224F or another data storage volume.

The application 216 may be configured and authorized to access on-device computing resources, such as the local data storage of the content, as well as remote computing resources such as a cloud storage service with which the device user has a user account. In an example of the latter, where the user device 224 is an IPHONE, the application 216 may include an API or another interface that, using the user's Apple ID and password, connects to a cloud storage network frontend 212 for the (IOS-native) ICLOUD data storage service and gains a certain level of access to the cloud storage 252 resources allocated to the user. In another example, the application 216 may have prompts in the user interface to select a compatible third-party storage service; a user of the user device 214 may select a provider, and the application 216 may select or obtain the corresponding API for connecting to the frontend 210 and gaining access to the user's cloud storage 232 resources. As described above, the user-specified storage location (i.e., cloud storage 232, 252) may include the associated share ledger 202, 204 as well as digital content 220, 240 that has been organized by the system as described below. In some embodiments, the application 216 may be further configured to access a frontend 208 of a cloud storage service used by the system to facilitate content sharing. For example, the application 216 may cause a provisioning service 208A of the data storage service to allocate storage resources 218 for the temporary storage of one or more of the data packets 230A that compose the package 230 (i.e., the encrypted content and metadata being offered for sharing). Additionally, the application 216 may cause a request router 208B to generate an access point, such as a uniform resource locator (URL) 218A, that exposes the temporary data store 218; the URL 218A can be provide to the receiving device 224, and the receiving device 224 can access the temporary data store 218 using the URL 218A to retrieve and/or delete the package 230. Alternatively, the request router 208B may create a uniform resource identifier (URI) or another identifier that can be provided to device that are authorized to access the temporary data store 218, and the request router 208B can receive requests for the stored data and use the identifier to locate and retrieve the data.

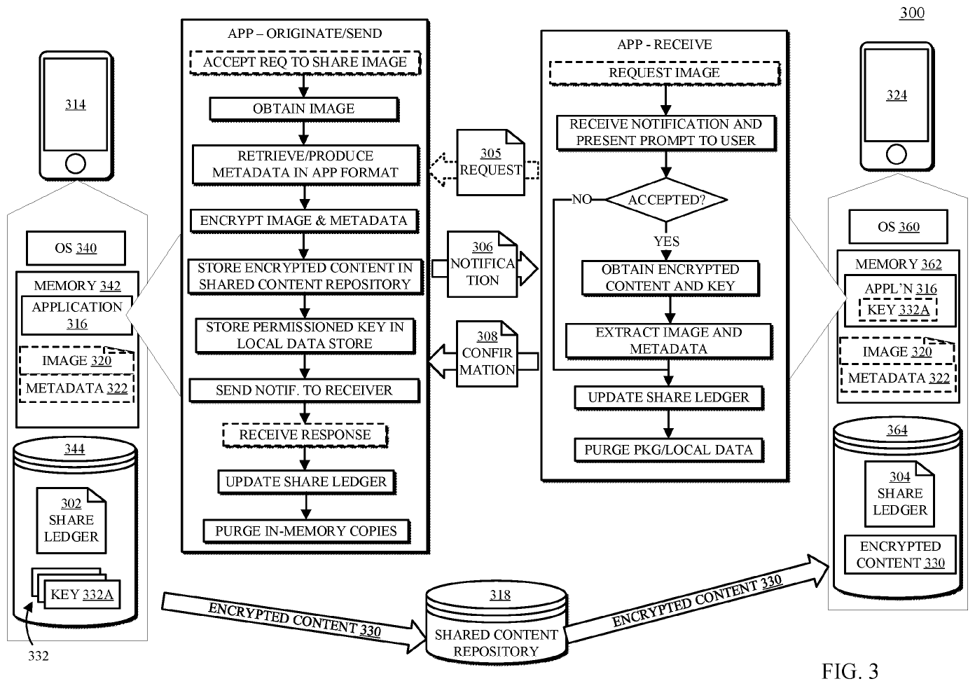

FIG. 3 illustrates another example set of computing systems of a computing environment 300 accessible by users of user computing devices 314, 324 via a computer network such as the internet. As in FIG. 1, FIG. 3 illustrates the conceptual operation of the present systems and methods implemented as a software application 316 installed on user devices 314, 324 each associated with a user account of a registered user of the system. Various components of FIG. 3 have analogues illustrated in FIGS. 1 and 2 and described above, and some detailed description is incorporated here from above. The environment 300 illustrates an example in which a sender may attempt to share content, such as a digital image, with a recipient using the application 316 installed on the parties' respective registered devices 314, 324. In other embodiments, the application 316, or a browser application, or another application, installed on a device 314, 324 may interface with one or more application servers that cooperate to perform the request and content processing methods described herein. See FIG. 11. The application 316 may comprise computer program instructions stored in memory 342, 362 of the corresponding device 314, 324; these instructions may be formatted for execution by one or more processors of the device 314, 324, and when executed, may cause the corresponding device 314, 324 to perform the application 316 tasks described herein. The application 316 may be formatted to execute within runtime and other execution environments, and to access file systems, provided within computing resources of the device 314, 324 according to the operating system 340, 360 of the corresponding device 314, 324. In particular, the application 316 may enable viewing, editing, sharing, and other management of digital content in ways that overcome the drawbacks described above.

FIG. 3 illustrates an example transaction in which two registered system users use the application 316 installed on their respective devices 314, 324 to share digital content, such as an image 320. Between the users' devices 314, 324 and the associated storage resources described further below, the application 316 may, in some embodiments, cause the devices 314, 324 to conduct a peer-to-peer encrypted transfer of a copy of the content data if both parties consent to the transfer. The illustrated example may be conducted as described in the following paragraphs, but it will be understood that the illustration and description are not limiting of the processes by which the present system may generally conduct the transfer.

The sending device 314 in some embodiments receives a request 305 from the receiving device 324 to download or receive the image 320. This may cause display of a prompt on the sending device 314 for the originating or sending user (“sender”) to accept the request to share the image 320 with the user of the receiving device 324 (“receiver”). In some embodiments, the sharing platform may enable users to create accounts and profiles that include a list of users that are known contacts or favorites; the sending device 314 may query this list to determine whether the receiver appears thereon, and if so, may automatically accept the request 305. In other embodiments, the sender may initiate the proposed share. If the sender accepts the request 305, or if the sender is initiating the share, the sending device 314 obtains the image 320 (e.g., from user-specified cloud storage, see FIG. 1) and may reformat any native metadata (e.g., in EXIF format or a platform-specific format), or store the metadata in app-specific metadata 322, as described above. The sending device 314 may additionally generate any new app-specific metadata 322 describing the image 320, such as contextual information regarding the new share. In some embodiments, the image 320 and app-specific metadata 322 may be stored in short-term or volatile memory 342 of the device 314, rather than a persistent memory store like the local storage 344. For example, the image 320 and metadata 322 may be stored in memory 342 resource allocated especially for the application 316 and providing access only to the application 316.

The sending device 314 encrypts the image 320 and app-specific metadata 322 to produce encrypted content 330 and a key 332A that is associated with the transaction and is required in order to decrypt the encrypted content 330. The key 332A may be stored with other keys 332 for shared content in the local device memory 344, while the encrypted content 330 is sent to a shared content repository 318, which may be a cloud-based or other remote data store that a host, application server, or data storage service (e.g., SIMPLE STORAGE SERVICE provided by Amazon) can access in order to provide the encrypted content 330 and other shared data to receiving devices that are authorized to request it. There may be multiple keys 332 generated and associated with a particular shared content (e.g., image 320), or with a particular storage location (e.g., secure URL of package 130/encrypted content 330 in temporary storage 118/repository 318), or with a transaction (e.g., sharing one or more images with one or more users, or editing or commenting on a shared content), or with a user (e.g., receiver, sender) or group of users, etc. The sending device 314 sends a notification 306 to the receiving device 324 that may contain the key 332A and any information needed to obtain the encrypted content 330 (or the encrypted content 330 itself, in some embodiments).

The receiving device 324 receives the notification 306, and may present a prompt to the recipient to accept or reject the request to share the image 320 and process the recipient's response. Additionally or alternatively, the receiving device 324 may automatically accept the share if the receiver previously requested it, or if the sender is found in the receiver's list of known contacts; other application 316 settings may cause the receiving device 324 to automatically decline the share, such as if the sender appears on a list of users the receiver has blocked. A confirmation 308 containing the recipient's response is sent back to the sending device 314. The sending device 314 may wait a preset request time-out period to receive the confirmation 308; upon receiving the confirmation 308, or if the request times out, the sending device 314 then updates the sender's share ledger 302 (described further below, and stored in the local device storage 344) to include an entry describing the image 320 transaction. In some embodiments, this entry may include the result of the share (i.e., accepted/completed or rejected), as well as app-specific metadata 322 thus far generated for the image 320, or a reference to the storage location of the metadata 322 (e.g., in user-specified cloud storage), and may also include information for identifying and locating the keys 332 and encrypted content 330 associated with the image 320 so that the image 320 can later be shared with other users without re-encrypting it.

If the recipient accepts the notification 306, the receiving device 324 stores the key 332A in memory 362 allocated to the application 316, obtains the encrypted content 330 from the repository 318, and extracts the image 320 and metadata 322 for display. In some embodiments, the image 320 and metadata 322 are not stored in persistent storage (i.e., local device storage 364), but in volatile memory 362 that the application 316 is authorized to modify. Thus, the application 316 can delete any of the key 332A, image 320, and metadata 322 even without permission to modify the persistent device stores 364. The encrypted content 330, however, may be larger in size and may be stored in the persistent device stores 364. For example, the encryption may convert the image 320 and metadata 322 into an encrypted string of characters, stored in an ASCII file that is approximately the same size as the original content files (though a compression algorithm may also be applied to reduce the size of the encrypted files). The system may also update the recipient's share ledger 304 (described further below, and stored in the local device storage 364) to include an entry describing the received image 320 and associated transaction.

When the recipient is done viewing and otherwise interacting with the image 320 and metadata 322, or if the recipient rejects the request, the receiving device 324 may delete any locally-saved (e.g, in memory 362) data regarding the request, including the image 320 and metadata 322. The device 324 prepares and sends a confirmation 308 to the sending device indicating whether the share was accepted and completed., the sending device 314 updates the sender's share ledger 302 (saved in the user-specified storage location, such as cloud storage 332 with the sender's content (including image 320) to include an entry describing the result of the share (i.e., accepted or rejected), and deletes any locally-saved (e.g, in memory 342) data regarding the request.

In some embodiments, while the recipient remains authorized to access the shared image 320, the receiving device 324 may retain the key 332A in memory 362 while also retaining the encrypted content 330 in the persistent local data storage 364; thus, when the recipient uses the application 316 to access the image 320, the application 316 again decrypts the image 320 and metadata 322 from the encrypted content 330 into memory 362. If the key 332A is lost, the encrypted content 330 may remain in data storage 364 but cannot be decrypted unless the recipient requests the key again from the sender. Either device 314, 324 may delete the encrypted content 330 from the repository 318 (or allow a storage timer to expire) once the preceding tasks are complete. Alternatively, the repository 318 may retain the encrypted content 330 for an indefinite amount of time; the sender can allow the receiver to re-download the encrypted content 330 if needed, and/or can share, or allow the receiver to share, the image 320 with additional users by including the location of the encrypted content 330 (and a corresponding key 332, such as the existing key 332A or a new key generated for the new recipient(s)) in a corresponding notification.

In this manner, some embodiments of the system configure the peer-to-peer private sharing of content so that the content can only be used (e.g., viewed, shared, etc.) by the receiver from within an instance of the application 316 executing on an authorized receiving device 324, and only if the owner (and possibly also a non-owning sender, if authorized) has set permissions allowing the receiver to perform the requested action. The owner can modify these permissions and promulgate the changes to the platform users via the network of user devices, causing the applications 316 of impacted users to allow or deny activity, and keep or discard data, accordingly. Further, each transaction involving the shared content can be recorded to each parties' private or synchronized shared ledgers 302, 304, creating a complete interaction timeline that essentially bestows the content with “memory” of how it has been shared.

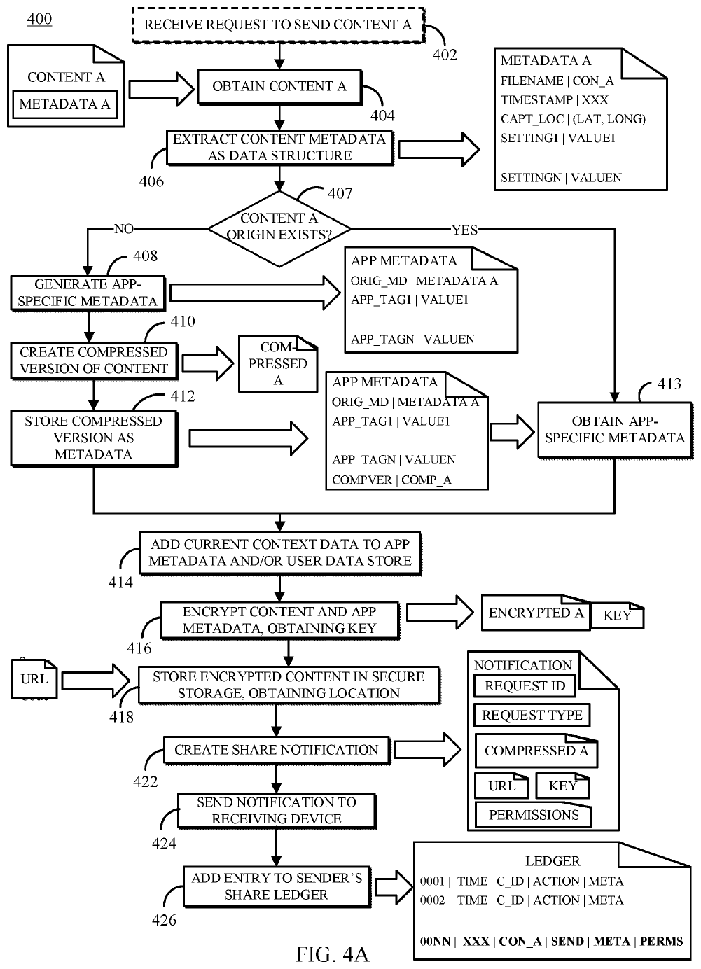

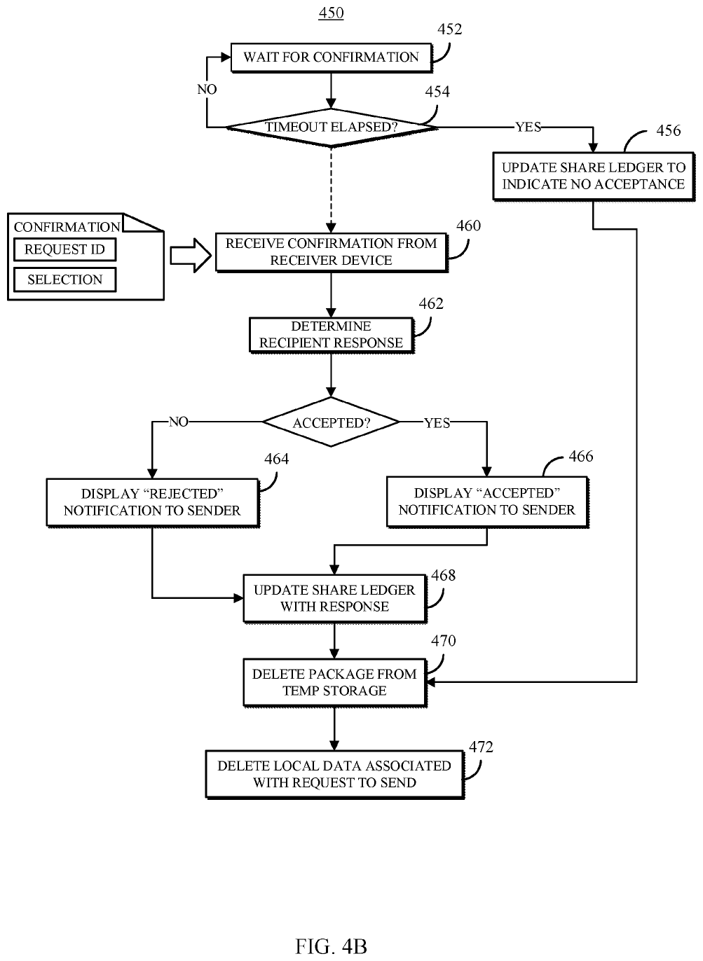

FIG. 4A illustrates an example method 400 performed by the system to initiate a request to share content (specifically, “CONTENT A” in the illustration) from a sender to a recipient. At 402, the system receives the request entered by the sender. The request includes the content and metadata, or an identifier and/or other necessary information to obtain the content with embedded or otherwise associated “original” metadata. At 404, the system obtains the content to be shared, and at 406 the system extracts the original metadata (describing target rich properties) from the content file(s) into a data structure (“METADATA A”). At 407, the system may determine whether an “origin” of the content already exists—that is, whether the content being shared has already been shared with application users or otherwise added to the application platform. If so, some of the intermediate data generated during the sharing process (e.g., at 408, 410, 412) already exists and may at 413 be obtained from the sender's application data storage rather than recreated. If there is no existing origin, at 408 the system generates additional app-specific metadata, if any, as structured data. For example, the system may convert the metadata into an app-specific structure/schema that can be used by devices/operating systems of any type. The system may further generate new metadata, such as tags and other parameters associated with desired rich properties, and store the new metadata as app-specific metadata.

At 410, the system may create a compressed version of the content. For example, when CONTENT A is an image, the system may create a thumbnail of the image, having a reduced dimension and/or resolution that is faster and less costly to store and transmit to other devices. At 412, the system may store the compressed version, or a reference (e.g., a file path) to the compressed version, in the app-specific metadata structure. In some embodiments, at 414 the system may again identify any other properties of the share that should be stored in the app-specific metadata or in an application data store. These properties may include context data that is not stored in app-specific metadata, or needs to be updated therein because a previous set of metadata was obtained (at 413). In some embodiments, at 414 the system may also process the retrieved context data to obtain context analytics and store them. For example, context data may be aggregated and analyzed to identify trends in content usage, determine a recent history (e.g., an ongoing comment thread or chat about the content), or determine whether the content is stale.

At 416, the system may encrypt the content, metadata, and app-specific metadata to produce the encrypted content and decryption key(s) as described above. At 418, the system may coordinate the storage of the encrypted content in secure, temporary data storage. For example, the system may connect to a cloud storage network/service to receive an allocation of storage space, and may send the package into the allocated space for storage. The storage service may generate a URL or other endpoint for accessing the allocated space and its contents, and at 418 the system may further receive the URL.

At 422, the system may create the notification to the receiver's device. The notification may include a request identifier for tagging resources associated with the request, as well as a request type, the compressed version of the content (i.e., thumbnail(s) of sent image(s), or another type of preview of the content), and the URL. The request may also include the generated key(s) or a reference thereto. Further, the request may include a set of permissions identified by the sender and used by the receiver's application to determine whether requested access to the shared content is authorized. The request type may be used to identify the appropriate prompt to display on the receiving device; alternatively, the notification may include the prompt itself, or a reference to the correct prompt (i.e., stored in the receiving device memory). At 424, the system may send the notification to the receiving device. For example, the sending device may encode the notification in an SMS message and send the SMS message to the receiving device using a standard smartphone transmission protocol. At 426, the system may create an entry describing the attempt to share CONTENT A with the recipient, and may append the entry to the sender's share ledger.

FIG. 4B illustrates an example method 450 performed by the system to process the recipient's response to the request of FIG. 4A. The system may wait (452) for a predetermined or user-specified timeout period to receive a confirmation from the receiving device. If the system determines (454) that the timeout period has elapsed without receiving the confirmation, at 456 the system may update the sender's share ledger (i.e., by adding another entry or modifying the previous entry associated with the request) to indicate that the recipient did not accept the request within the time allowed. When the confirmation is received (460), at 462 the system determines whether the recipient accepted or rejected the request. If the recipient declines, at 464 the system notifies the sender that the request was declined; if the recipient accepts, at 466 the system notifies the sender that the request was accepted. At 468, the system updates the sender's share ledger (i.e., by adding another entry or modifying the previous entry associated with the request) to indicate the recipient's selection. At 470, the system deletes the temporary stored data, and at 472 the system deletes any locally-stored data associated with the request; the system does not save the notification or confirmation anywhere, in some embodiments.

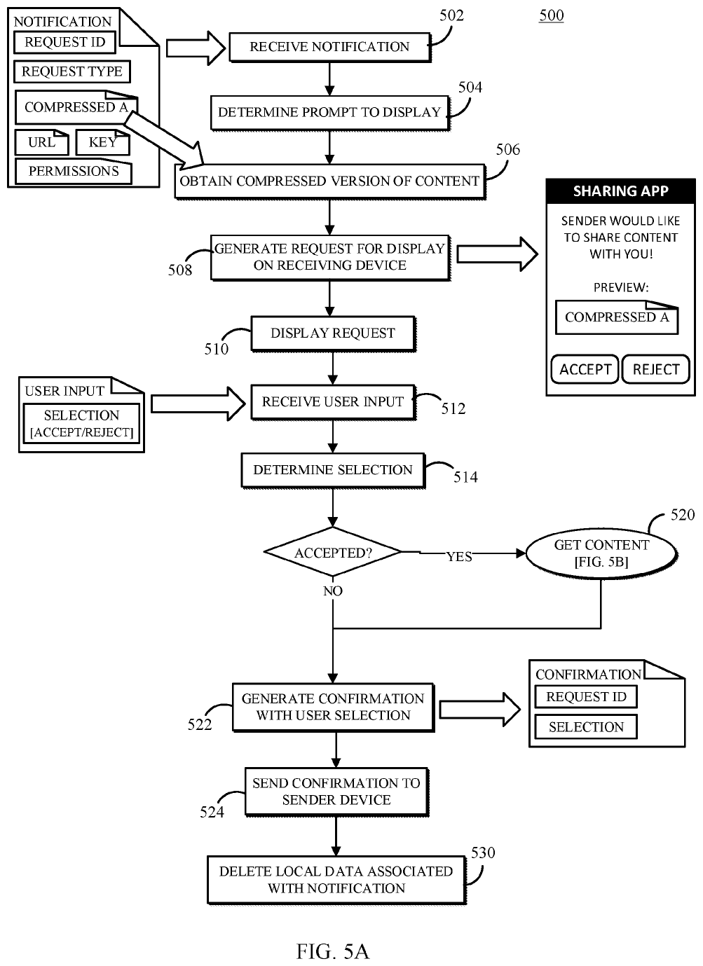

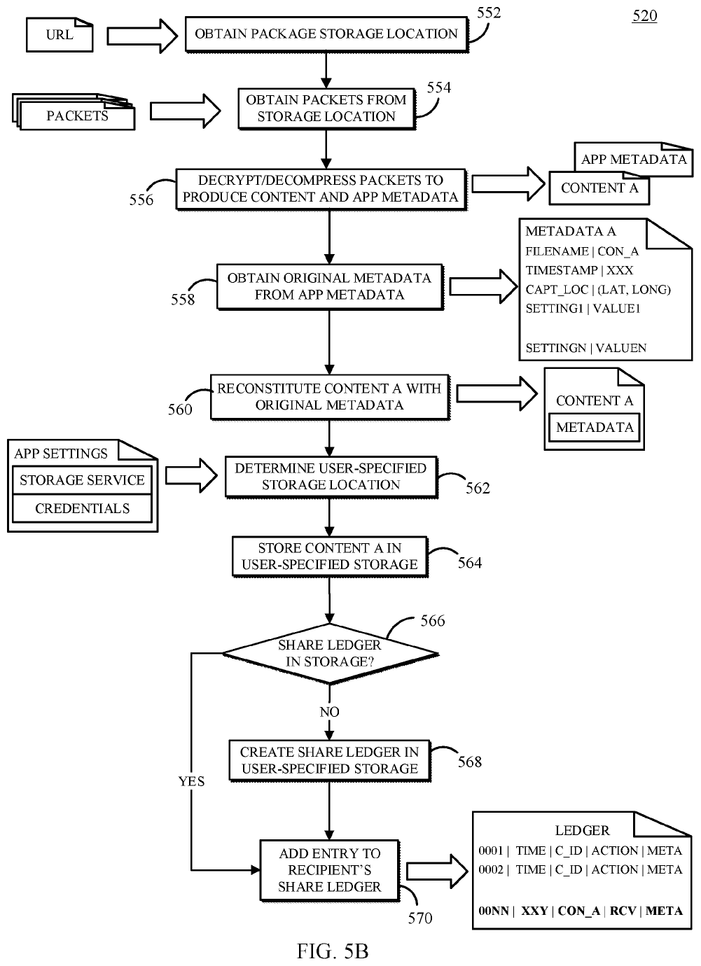

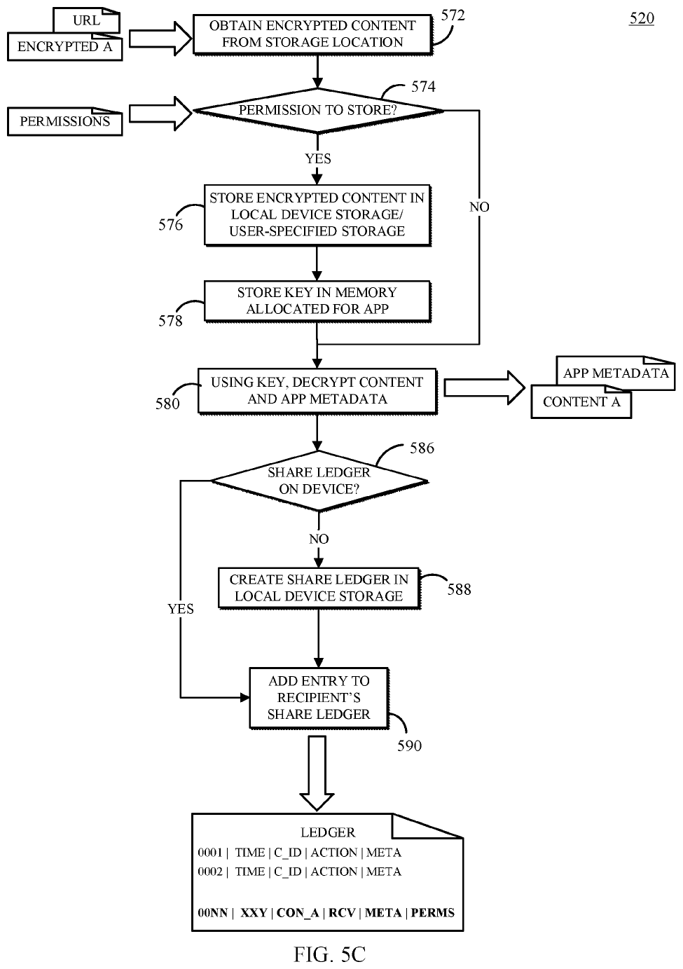

FIG. 5A illustrates an example method 500 performed by the system to respond to the request to share content of FIG. 4A. At 502, the system receives the notification generated at step 422. At 504, based on data in the notification (e.g., a request type identifier, or prompt text), the system determines which prompt should be displayed to the recipient. At 506, the system obtains the compressed version of the content (e.g., from the notification, or from a storage location indicated by the notification), and at 508 the system generates a visual representation of the request for display on the receiving device. For example, the system may format a graphic user interface (GUI) screen that displays: text indicating the sender (e.g., identified by the phone number associated with the sending device) wants to share content; a depiction of the compression version of the content (e.g., the thumbnail of an image); and, one or more interactive elements (e.g., buttons) selectable by the recipient to accept or reject the request. At 510, the system may cause the GUI screen to be displayed on the receiving device, and at 512 the system may receive user input submitted by the recipient in response to the display of the GUI screen.

At 514, the system may determine from the user input whether the recipient chose to accept or reject the request. If the request is accepted, at 520 the system executes a process to obtain the content, as described below with respect to FIG. 5B. If the request is rejected, or after the content is obtained, at 522 the system generates the confirmation including the request identifier and am indication of the recipient's choice. At 524, the system sends the confirmation to the sending device, and at 530 the system deletes/purges locally stored data associated with the request.

FIG. 5B illustrates an example method 520 of obtaining the content shared via the request of FIG. 4A. At 522, the system obtains the URL from the notification, and at 554 the system uses the URL to access the temporary cloud storage and transfer the image file packets to the receiving device. At 556, the system may decrypt or decompress the received packets to produce the shared content and the application-specific metadata that was created before or during the share. At 558, the system may obtain the complete original metadata from the application-specific metadata, such as by extracting the original metadata that was stored in the app-specific metadata as a data structure, or by converting the app-specific metadata back into the original metadata format as described below. At 560, the system may “reconstitute” the original content by associating the extracted original metadata with the decrypted/decompressed content. If the receiver has a cloud storage of choice (credentials to access cloud storage provided at registration of the app), at 562 the system determines the access process for the cloud storage and at 564 stores the reconstituted content in the specified location. In one embodiment, two files get created at the destination (i.e., local device storage and/or cloud storage): one, the actual image file, reconstituted with the metadata; and two, if it does not exist (determined at 566, created at 568), a “ledger” file containing an entry or record for each transaction conducted by the application, the record including the application-specific metadata. In the future, the ledger file will grow as images continue to be shared from or to users' cloud storage through the application; after the one-time ledger file creation, a record of each future image transmission gets appended into it (i.e., at 570).

FIG. 5C illustrates another example method 520 of obtaining the content shared via the request of FIG. 4A. At 572, the system obtains the URL from the notification and uses it to retrieve the encrypted content and, in some embodiments, hold the encrypted content in device memory allocated to the application. At 574, the system determines whether the receiver has permission to store the shared content on the local device (i.e., in persistent storage) or in the receiver's cloud storage. The permissions may be included in the notification, or the application may query the sender's application for a determination of the permission. If the user has permission to store the content, at 576 the system may store the encrypted content in the corresponding storage locations of the user, and at 578 the system may store the key for decrypting the content in device memory allocated to the application.

At 580, the system may decrypt or decompress the encrypted content to produce the shared content and the application-specific metadata that was created before or during the share. At 586, the system determines whether a “ledger” file containing an entry or record for each transaction conducted by the application is stored on the device; if not, at 588 the system creates the shared ledger and adds a record including the application-specific metadata. If the shared ledger exists, a record of the image transmission gets appended into it (i.e., at 590).

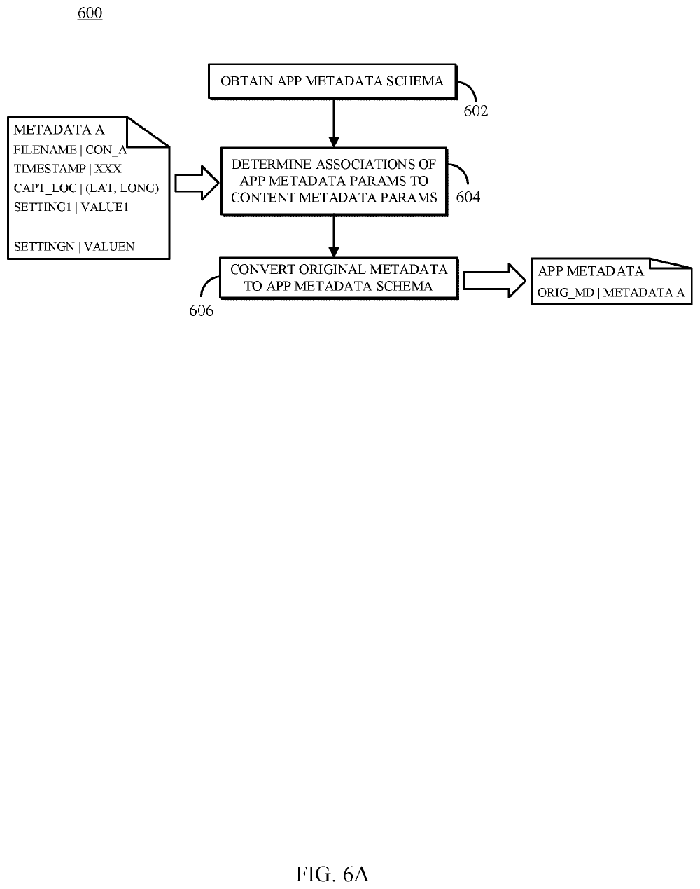

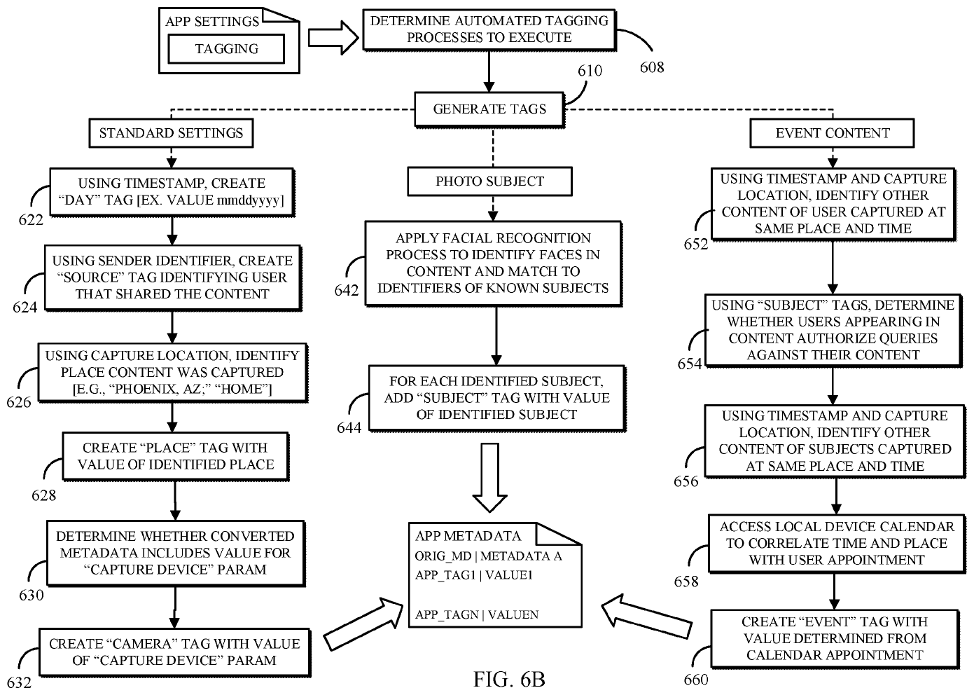

Referring to FIGS. 6A-B, a system in accordance with the present disclosure may perform one or more processes to maintain the original metadata associated with shared content, and further may generate application-specific (i.e., relevant to and used by the software application(s) of the present system) metadata that facilitates enhanced organization and searching of digital content libraries/databases. In the example method 600 of FIG. 6A, the system processes a request to share CONTENT A, having METADATA A, by generating the application-specific metadata for CONTENT A (i.e., at 408 of FIG. 4A). At 602, the system may obtain an application-specific metadata (“app metadata”) schema. The app metadata schema may include a plurality of parameter-value pairs that each store a data element describing the content. The app metadata schema may include both standard and nonstandard metadata parameters for the associated content. For example, the app metadata may include a “timestamp” parameter, which is common to every type of capture device (though the format of the corresponding value may differ) as well as several standardized content metadata formats; the app metadata may also include an “event” parameter, which may be generated by grouping content having a temporal and geographical relationship as described further below.

In some embodiments, the app metadata schema may include various sets of parameters that are each associated with a corresponding parameter of the content metadata generated by at least one device type. Thus, the app metadata schema may be configured to interpret the metadata of content captured by a device of a first device type (e.g., APPLE IPHONE) and/or a device of a second device type (e.g., an ANDROID device) by converting the parameters of the device's “native” metadata schema into corresponding parameters of the app metadata schema. At 604, the system may read the parameters of METADATA A schema and determine the parameters of the app metadata schema that are associated with the native schema. At 606, the system may then convert the METADATA A schema to the app metadata schema. For example, the system may store all of the values of the associated parameters in the native schema into a data structure of the app metadata schema. In another example, the system may simply create a new data record including a single parameter having a value that is a data structure, and the system may store the METADATA A data structure directly into the new data record.

In some embodiments, the present system enables “tagging” of shared content, such as images, with parameter-value pairs (known as “tags”) that store information describing the context of the content or the environment in which the content was captured or shared. Tagging can include manual tagging and/or partially- or fully-automated tagging methods. Any suitable contextual data element may be captured using a tag. FIG. 6B illustrates several non-limiting example methods for automatically tagging shared content with additional application-specific metadata parameter-value pairs. At 608, the system may determine which automated tagging processes to execute. The “tagging” may be controlled by the app metadata schema: any app-specific parameters may be characterized as “tags” that the system must discover an associated value for. In some embodiments, the tags may be identified from the app metadata schema. Additionally or alternatively, the tags and their corresponding tagging processes may be determined from application settings entered by the user or stored by default. At 610, the system may execute the determined processes (and/or other processes, in some embodiments) to generate the values for the tags. The N tags and their corresponding values, once identified/generated, may be added to the app metadata structure associated with the shared content.

In one embodiment, the system may always tag newly-shared content—that is, content that has not been shared within the software application before—using “standard settings.” At 622, the system may use the value of the timestamp parameter to generate an application-specific date format. At 624, the system may use an identifier of the sender to generate a “source” tag identifying the user that shared the content. The value of the “source” tag may be the sender's username, full name, etc. At 626 and 628, the system may create a “place” tag that, using GPS or other data, colloquially identifies the place that the content was captured (e.g., “home”). At 630, the system may determine that the conversion of the original metadata preserved identifying information of the device that captured the content, and at 632 the system may create a “camera” tag that identifies the capture device using a colloquial or otherwise searchable value.

In some embodiments, the system may additionally or alternatively tag a shared image with information identifying one or more of the individuals appearing in the image (e.g., the “subject” of a digital photograph). At 642, the system may apply facial recognition algorithms, or other artificial intelligence algorithms, to the image in order to identify the subject(s). For example, the sharing application may access one or more data stores containing photographs of the users of the sharing platform—these may be profile photos uploaded and/or selected by the user, photos/images previously shared or otherwise made accessible in the sharing platform and tagged as containing specific users, etc. The facial recognition software executing within the sharing application may then apply its matching processes to determine the identifiers of users that are present in the photo. At 644, the system may add a “subject” tag for each of the identified users, storing the user identifiers as values for the “subject” parameter.

In some embodiments, the system may additionally or alternatively tag a shared image with information identifying the image as relevant to a group of images having common traits and being shared on the sharing platform. Non-limiting examples of groups that can be created in the sharing application include: a photo album created by a user or created automatically, associating photos taken at approximately the same time, or near the same location, or featuring the same people, or related in a manner identified by the user (i.e., custom tags), etc. In the illustrated example, the automated tagging processes include a process for identifying images, held by multiple users, which were captured at the same event. At 652, the system may use the timestamp and location tags of a user's images to identify a group of images taken at approximately the same time and place. At 654, the system may identify images in the group that have “subject” tags, and may obtain the identifiers of other users appearing the images; then, the system may determine whether the identified users have authorized the system to use the users' shared content to aggregate data across multiple users. For users that have authorized such operations, at 656 the system may use the timestamp and location of the first image to identify additional images taken at approximately the same time and place. At 658, the system may determine that all of the identified images were captured at a particular event, by accessing the calendar information (e.g., a calendaring app) in the user's computing device, and correlating the time of image capture with an event appearing on the calendar. At 660, the system may tag any or all of the identified images with an “event” tag and a value that is determined from the correlated calendar appointment. For example, the system may determine from the calendar and GPS that a “source” of an image was at a Weezer concert when the image was taken, and may use this information to develop a descriptive tag for the event.

In another example process, the system can automatically generate a “memory timeline” of images depicting a shared experience of multiple users of the platform. For example, a set of the platform's users, each of whom have downloaded and installed the present sharing application on his/her respective computing device(s), may be classmates graduating from a school in the same discipline. A first user in this group may create a “School Friends” photo album, granting access (i.e., “permissions” for users, as described above) to all class members. Then, when any of the users with access to “School Friends” takes a photo via phone camera and transfers it to the album, the photo and a notification featuring a preview and an “accept” prompt are instantly received by all members, using the peer-to-peer transferring described above. Users may further be enabled to comment on shared photos, see the number of views, etc. Each member may also be able to create their own folders as per category/filters, for example: 1) Arrange by date & time (all pics arranged in sequence); 2) Arrange by Location (All pics arranged by location and date & Time sequence); 3) Arrange by member (e.g., all pics where a particular member is present/facial recognition); and the like. Additionally, one or more of the users may have the ability to create a video of all photos in the album, with or without music.

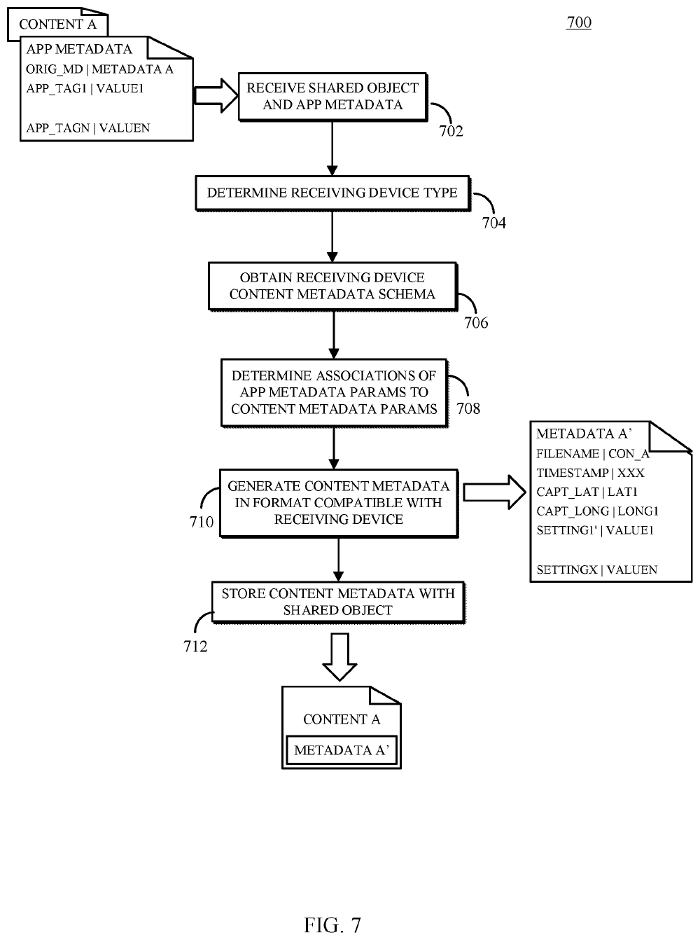

FIG. 7 illustrates an example method 700 by which the system formats shared content that is accepted by the receiver so that the content is compatible with the receiving device. At 702, the system receives the shared content object and the app metadata associated with the content, as described above. At 704, the system may determine the receiving device type. In embodiments where an application server is serving the content, the server may query the receiving device for this information; where the receiving device, via an installed application, is itself performing this method, the device type may be stored or accessible locally by the application. At 706, the system may use the device type to obtain the content metadata schema that is native to, or at least compatible with, the receiving device. At 708, the system may determine the corresponding associations between parameters of the app metadata and parameters of the content metadata, as described above. At 710, the system may generate a content metadata structure comprising parameter-value pairs that each store data elements obtained from the app metadata. For example, the app metadata associated with CONTENT A may be reformatted into a METADATA A′ structure that contains some or all of the information in METADATA A of FIG. 4A and is formatted for use by the receiving device. At 712, the system may store the received shared content with the reconstituted, compatible metadata structure, as described above.

As described above, steps of the various processes for sharing and managing digital content include converting metadata embedded within or accompanying the content between at least partially disparate schemas. See e.g. FIG. 4A at 408, FIG. 5B at 558, 560, FIG. 6A-B, and FIG. 7 at 706-710, which describe converting between schemas for content metadata of a particular device and app-specific metadata. In other embodiments, the sending device, receiving device, or application server may directly convert between schemas of different devices, so that, for example, an image captured using an IPHONE camera may be shared to an ANDROID device with its rich properties, identified by the original metadata, intact. This metadata conversion may be supported using any suitable standardized metadata schema, such as EXIF and/or Design rule for Camera File system (DCF) formatting. Additionally, the system may store one or more conversion tables identifying common metadata parameters between different schemas; the system may retrieve the appropriate table(s) to perform the conversion. An example table of common metadata parameters for IOS and ANDROID devices is provided in TABLE 1.

TABLE 1
Determination of Common Metadata Fields Across Mobile Platforms

| Android | iOS | Common |
|---|---|---|
| image_size | Camera--> | image_size |
| last_modified | make | last_modified” (common) |
| image_width | model | image_width” |
| | | (common)(ExifImageWidth in IOS) |
| image_height | exposure | image_height” |
| | | (common)(ExifImageHeight in IOS) |
| focal_length | aperature | focal_length” (common)(Fnumber) |
| flash | focal length | flash” (common) |
| white_balance | ISO speed | white_balance” (common) |
| gps_longitude | flash | gps_longitude” (common) |
| gps_altitude | | gps_altitude” (common) |
| aperture_value | EXIF--> | aperture_value” (common) |
| x_resolution | make | x_resolution” (common) |
| y_resolution | model | y_resolution” (common) |
| resolution_unit | xResolution | resolution_unit” (common) |
| exif_version | yResolution | exif_version” (common) |
| component_configuration | resolution unit | component_configuration” (common) |
| shutter_speed_value | software | shutter_speed_value” (common) |
| brightness_value | modify date | brightness_value” (common) |
| metering_mode | tile width | metering_mode” (common) |
| subject_area | tile height | subject_area” (common) |
| sub_sec_time_original” | exposure time | sub_sec_time_original” (common) |
| sub_sec_time_digitized | FNumber | sub_sec_time_digitized” (common) |
| flash_pix_version | exposure program | flash_pix_version” (common) |
| sensing_method | ISO | sensing_method” (common) |
| scene_type | exif version | scene_type” (common) |
| exposure_mode | date time original | exposure_mode” (common) |
| focal_length_in_35_mm_format | create date | focal_length_in_35_mm_format” |
| | | (common) |
| scene_captured_type | components configuration | scene_captured_type” (common) |
| gps_latitude_ref | shutter sped value | gps_latitude_ref” (common) |
| gps_latitude | aperature value | gps_latitude” (common) |
| gps_longitude_ref | brightness value | gps_longitude_ref” (common) |
| gps_altitude_ref | exposure compensation | gps_altitude_ref” (common) |
| gps_speed_ref | metering mode | gps_speed_ref” (common) |
| gps_speed | flash | gps_speed” (common) |
| gps_dest_bearing | focal length | gps_dest_bearing” (common) |
| gps_dest_bearing_ref | subject area | gps_dest_bearing_ref” (common) |
| iso_speed | sub sec time original | iso_speed” (common) |
| lens_make | sub sec time digitized | lens_make” (common) |
| lens_model | flash pix version | lens_model” (common) |
| lens_info | exif image width | lens_info” (common) |
| gps_datestamp | exif image height | gps_datestamp” (common) |
| gps_timestamp | sensing method | gps_timestamp” (common) |
| gps_h_positioning_error | scene type | gps_h_positioning_error” (common) |
| | exposure mode | |
| | white balance | |
| | focal length 35 mm format | |
| | scene capture type | |
| | lens info | |
| | lens make | |
| | lens model | |
| | gps parameters | |
| | XMP--> | |
| | XMP toolkit | |
| | creator tool | |
| | modify date | |
| | create date | |

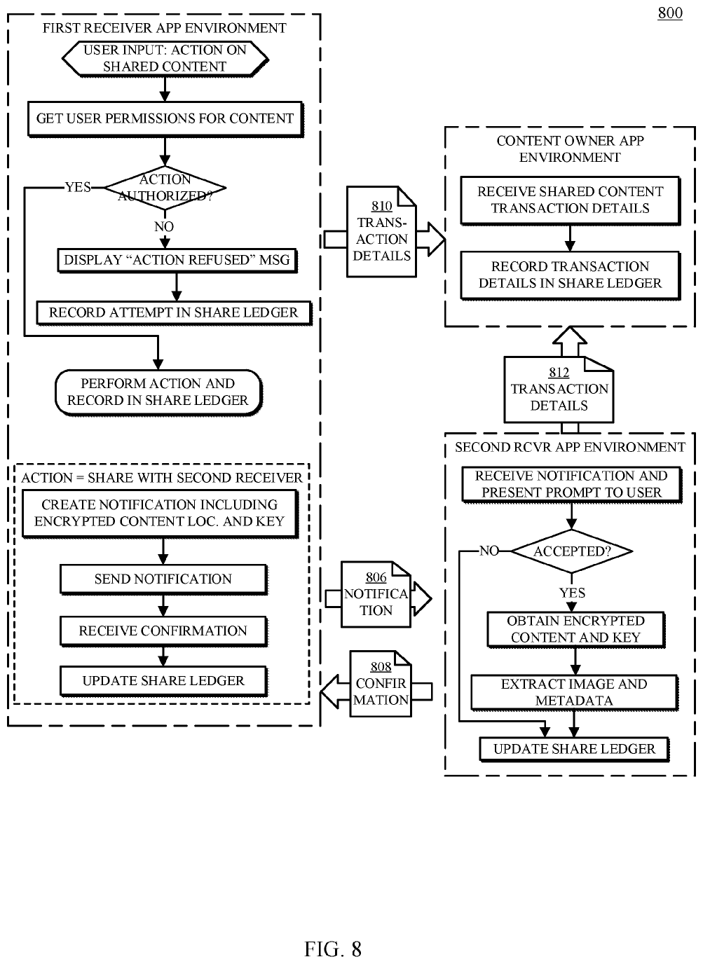

FIG. 8 illustrates an example set of processes 800 conducted between the application environments of multiple users of the sharing application, in order to record a chain of sharing content in the corresponding shared ledgers of the participants. In particular, the actions are conducted only if the corresponding permissions set by the content owner allow them. Nevertheless, transaction details 810, 812 of both allowed and denied transactions associated with shared content can be reported to the application environment of the content owner and recorded on the owner's shared ledger. In the illustrated example, the owner has shared an image with a first receiver, and the first receiver is attempting to share the image with a second receiver. If the share is authorized (i.e., the first receiver is authorized to share the image, and the second receiver is authorized to receive the image), the first receiver sends the notification 806 to the second receiver and the second receiver responds with the confirmation 808, as described above. The details 810 of the first receiver's transactions are recorded at least into the first receiver's shared ledger, and are further sent to the owner for recording in the owner's shared ledger. The details 812 of the second receiver's acceptance or rejection of the share are recorded in the second receiver's shared ledger and sent at least to the owner as well.

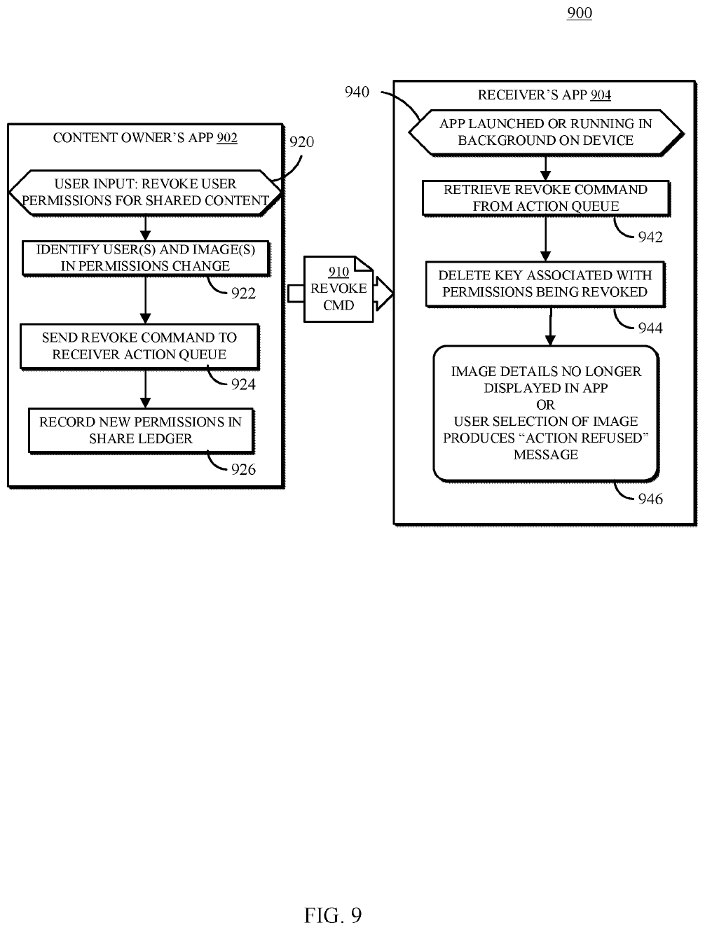

In FIG. 9, a process 900 implementing a content owner's revocation of the receiver's access to a shared content is depicted. The content owner's application 902 receives a user input 920 indicating that the owner wants to revoke the receiver's access, effectively deleting the shared content from the receiver's available repository. At 922 the app 902 identifies the user and the image be affected by the change, and at 924 the app 902 sends a revoke command 910 to the receiver. For example, the system may maintain a notification queue for each user, and the correspond application may retrieve and process notifications. At 926, the app 902 may record the new permissions in the share ledger.

The receiver's application 904 is executing at 940, either by being launched by the user or by executing in the background on the user's device. At 942 the app 904 receives the revoke command 910. For example, the app 904 may access the receiver's notification queue and retrieve the notification containing the command 910. At 944 the app 904 may process the revoke command 910, such as by deleting the previously-received key that is used to decrypt the encrypted content stored on the user device to produce the image and metadata. Without the key, the app 904 cannot decrypt and show or perform other actions on the shared content; the user interface of the app 904 may subsequently (at 946) no longer display the corresponding content as accessible, or may display an error or “action refused” message to the receiver if the receiver tries to open the content in the app 904.

The various embodiments described herein can be implemented in a wide variety of operating environments, which in some cases can include one or more user computers, computing devices or processing devices which can be used to operate any of a number of applications. User or client devices can include any of a number of computers, such as desktop, laptop or tablet computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network. These devices also can include virtual devices such as virtual machines, hypervisors and other virtual devices capable of communicating via a network.

Various embodiments of the present disclosure utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network, and any combination thereof. In some embodiments, connection-oriented protocols may be used to communicate between network endpoints. Connection-oriented protocols (sometimes called connection-based protocols) are capable of transmitting data in an ordered stream. Connection-oriented protocols can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In embodiments utilizing a web server, the web server can run any of a variety of server or mid-tier applications, including Hypertext Transfer Protocol (“HTTP”) servers, FTP servers, Common Gateway Interface (“CGP”) servers, data servers, Java servers, Apache servers, and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python or TCL, as well as combinations thereof. The server(s) may also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers, or combinations of these and/or other database servers.

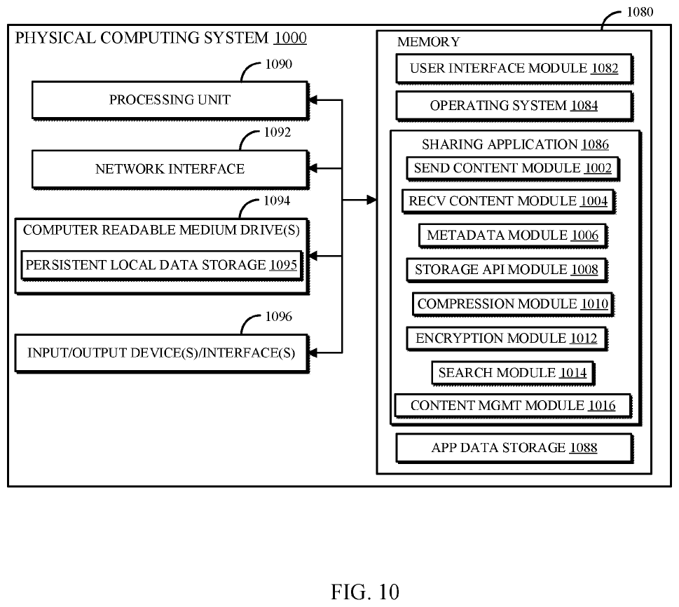

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Referring to FIG. 10, where a system includes physical computerized devices 1000, each such device can include hardware elements that may be electrically coupled via a bus, the elements including, for example, at least one central processing unit (“CPU” or “processor”) 1090, at least one input device (e.g., a mouse, keyboard, controller, touch screen, or keypad) and at least one output device (e.g., a display device, printer, or speaker) managed by an input/output device interface 1096. Such a system may also include one or more storage devices 1094 that use computer-readable media, such as disk drives, optical storage devices, and solid-state storage devices such as random access memory (“RAM”) or read-only memory (“ROM”), as well as removable media devices, memory cards, flash cards, etc. In some embodiments, storage devices 1094 may be internal to (e.g., within a case or other housing of) the computing device 1000, and/or may be external and coupled to the computing device 1000 (e.g., an external hard drive). A storage device 1094 may implement, or multiple storage devices 1094 may cooperate to implement, persistent local data storage 1095 that stores data accessible by the computing device 1000 without having to access a computing network. In various embodiments, examples of such data stored in persistent local data storage 1095 may include, but are not limited to, one or more of: the program instructions for executing the sharing application 1086; locally-stored copies of content, such as images captured by the imaging device of the computing device 1000, and encrypted versions of content shared using the sharing application 1086; a shared ledger as described herein, etc.

Such devices also can include a computer-readable storage media reader, a communications device (e.g., a modem, a network interface 1092 (wireless or wired card), and working memory 1080 as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device 1080, including an operating system 1084 and application programs, such as a sharing application 1086 or web browser. Runtime and/or execution resources, such as on-device temporary data storage 1088 for the sharing application 1086, may also be allocated in the working memory device 1080. In addition, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

A sharing application 1086 in accordance with this disclosure may include a plurality of modules, such as program functions, that alone or in cooperation with other modules execute the computerized tasks described herein. Non-limiting examples of such modules include: a send content module 1002 for executing tasks related to requesting to share content and sharing content; a receive content module 1004 for executing tasks related to receiving and accepting/declining a share request and obtaining the shared content; a metadata module 1006 for processing original metadata associated with content, and for generating application-specific metadata; a storage API module 1008 for loading and executing the proper data storage service API; a compression module 1010 and an encryption module 1012 for performing data compression and encryption algorithms on request data; a search module 1014 for enabling content library search functions using rich properties as described herein; and, a content management module 1016 for performing content management functions including any of the exemplary organizational or collaborative operations described herein, and any other commonly known digital content management functions.

FIG. 11 illustrates another example computing environment 1100 representing a modification of the computing environment 200 of FIG. 2. In some embodiments, as illustrated, the present system may include one or more application servers 1160 that perform various steps of the digital content sharing and management processes described above and otherwise contemplated herein. An application server 1160 may be any suitable physical computing system, virtual computing system (e.g., virtual machine or fleet of virtual containers), or combination thereof. The application server(s) 1160 may communicate with a software application 1116 installed on user devices 214, 224 to perform the digital content sharing and management processes, as described above. In some embodiments, the application server(s) 1160 may communicate with the cloud storage network frontend 208 of the data storage service that is configured to facilitate temporary secure storage of the shared content data package 230 (and, optionally, provide the package 230 for retrieval by the receiving device 224 at the URL 218A). In some embodiments, the application server(s) 1160 may further communicate with the cloud storage network frontend(s) 210, 212 of the preferred data storage services of one or both of the sender and recipient.

The specification and drawings are to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. In some embodiments, the code is stored on set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media may comprise multiple non-transitory computer-readable storage media and one or more of individual non-transitory storage media of the multiple non-transitory computer-readable storage media may lack all of the code while the multiple non-transitory computer-readable storage media collectively store all of the code. Further, in some examples, the executable instructions are executed such that different instructions are executed by different processors. As an illustrative example, a non-transitory computer-readable storage medium may store instructions. A main CPU may execute some of the instructions and a graphics processor unit may execute other of the instructions. Generally, different components of a computer system may have separate processors and different processors may execute different subsets of the instructions.

Accordingly, in some examples, computer systems are configured to implement one or more services that singly or collectively perform operations of processes described herein. Such computer systems may, for instance, be configured with applicable hardware and/or software that enable the performance of the operations. Further, computer systems that implement various embodiments of the present disclosure may, in some examples, be single devices and, in other examples, be distributed computer systems comprising multiple devices that operate differently such that the distributed computer system performs the operations described herein and such that a single device may not perform all operations.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-readable program product installable on a plurality of computing devices in electronic communication with each other and with at least one application server over one or more computer networks, the computer-readable program product comprising program instructions that, when executed by a corresponding processor of each of the plurality of computing devices, cause the plurality of computing devices to, via communications with each other and with the at least one application server, implement a content sharing system in which, using the computer-readable program product:
a plurality of users of the content sharing system each register a corresponding device of the plurality of computing devices with the content sharing system via an account of the user, each user of the plurality of users having a corresponding user identifier within the content sharing system, and each device of the plurality of computing devices having a corresponding device identifier within the content sharing system;
a first user device of the plurality of computing devices, the first user device associated with a first user of the plurality of users:
displays a user interface of the computer-readable program product to the first user;
receives, via the user interface, a selection of stored content to share with the second user;
determines that the stored content has not been shared using the content sharing system;
obtains the stored content from a first user-specified cloud storage accessible using credentials of the first user;
processes the stored content for sharing within the content sharing system to produce shared content;
generates and sends to the second computing device, via a first computing network of the one or more computing networks, a notification describing an attempt to share the shared content;
receives a confirmation from the second computing device, the confirmation describing an acceptance or rejection of the notification by the second user; and
performs a first action based on the confirmation; and
a second user device of the plurality of computing devices, the second user device associated with a second user of the plurality of users:
receives the notification;
displays, to the second user in the user interface, information associated with the notification, the information including a prompt for accepting or rejecting the shared content;
receives a user input comprising a response to the prompt;
determines whether the response is an acceptance or a rejection;
responsive to a determination that the response is an acceptance, obtains the shared content; and
generates the confirmation including the response and sends the confirmation to the first user device.

2. The computer-readable program product of claim 1, wherein the first user device is a mobile device having a first operating system and a first metadata schema native to the first operating system, and the second user device has a second operating system different from the first operating system and a second metadata schema native to the second operating system, and within the content sharing system, using the computer-readable program product, the first user device and the second user device cooperate to convert original metadata associated with the stored content from the first metadata schema to the second metadata schema without loss of any of the original metadata.

3. The computer-readable program product of claim 2, wherein to cooperate to convert the original metadata, using the computer-readable program product:
the first user device:
obtains an application-specific metadata schema associated with the computer program product;
determines a plurality of first parameters of the first metadata schema each are associated with a corresponding parameter of a plurality of second parameters of the application-specific metadata schema; and
copies corresponding values of the plurality of first parameters in the original metadata into a first data structure having the application-specific metadata schema as the corresponding values of the second parameters to produce application metadata; and
shares the stored content with the second user; and
the second user device:
determines the stored content has been shared with the second user;
receives the application metadata;
obtains the application-specific metadata schema;
determines a plurality of third parameters of the second metadata schema each are associated with a corresponding parameter of the plurality of second parameters of the application-specific metadata schema; and
copies corresponding values of the plurality of second parameters in the application metadata into a second data structure having the second metadata schema as the corresponding values of the third parameters to reconstitute the original metadata in the second metadata schema.

4. The computer-readable program product of claim 3, wherein the stored content is an image, and within the content sharing system implemented by execution of the program instructions:
to share the stored content with the second user, the first user device sends the image and the application metadata to a temporary cloud storage; and
the second user device, responsive to a determination that the stored content has been shared with the second user:
obtains the image and the application metadata from the temporary cloud storage; and
subsequent to reconstituting the original metadata, stores the image and the original metadata in a user-specified cloud storage accessible with credentials of the second user.

5. The computer-readable program product of claim 1, wherein the content sharing system implemented by execution of the program instructions further manages one or more share ledgers each comprising entries that describe transactions associated with each shared content.

6. The computer-readable program product of claim 5, wherein the one or more share ledgers include a first share ledger associated with the first user and a second share ledger associated with the second user.

7. The computer-readable program product of claim 6, wherein the first share ledger is stored in persistent local data storage of the first user device and the second share ledger is stored in persistent local data storage of the second user device.

8. The computer-readable program product of claim 5, wherein the content sharing system implemented by execution of the program instructions synchronizes the one or more share ledgers.

9. The computer-readable program product of claim 1, wherein the stored content comprises an image and original metadata describing the image, and within the content sharing system implemented by execution of the program instructions:
to produce the shared content, the first user device converts the original metadata into application metadata and compresses the image to produce a compressed image, the shared content comprising the image and the application metadata;
to generate the notification, the first user device stores the compressed image in the notification, the second user device displaying the compressed image in the user interface with the prompt;
to share the shared content with the second user, the first user device sends the shared content to a data repository of the content sharing system; and
the second user device, responsive to the second user accepting the notification:
obtains the shared content from the data repository; and
processes the shared content for display in the user interface.

10. The computer-readable program product of claim 9, wherein:
the first user device:
encrypts the shared content to produce encrypted content and a permissioned key;
sends the encrypted content to the data repository as the shared content;
sends the permissioned key to the second user device in the notification; and
maintains a set of permissions associated with one or both of the second user and the shared content, the set of permissions determining authorized actions that the second user can perform using the shared content; and
the second user device:
obtains the encrypted content from the data repository; and
to process the shared content, uses the permissioned key to decrypt the encrypted content into the shared content, enabling the second user device to access and display the image.

11. The computer-readable program product of claim 10, wherein the permissioned key is accessible by the second user device only when the computer-readable program product is executing, the shared content being inaccessible to the second user device outside of the content sharing system except as the encrypted content, and

12. The computer-readable program product of claim 11, wherein the second user device stores the encrypted content in persistent local device storage, temporarily stores the decrypted image in device memory allocated to the computer-readable program product, and, responsive to completing an authorized action on the image, deletes the image from the device memory.

13. The computer-readable program product of claim 10, wherein the user interface enables the first user to modify the set of permissions, and within the content sharing system, using the computer-readable program product:
the first user device:
receives a modification to the set of permissions;
determines that the modification comprises a revocation of the second user's access to the shared content; and
generates a revoke command and sends the revoke command to the second user device; and
the second user device:
receives the revoke command;
determines that the revoke command is associated with the shared content; and
subsequent to receiving the revoke command, prevents the second user from performing an action on the image.

14. The computer-readable program product of claim 13, wherein the second user device prevents the second user from performing the action on the image by deleting the permissioned key.

15. The computer-readable program product of claim 14, wherein the encrypted content remains stored in persistent local device storage of the second user device after the permissioned key is deleted.
